(19) United States
(12) Patent Application Publication
(10) Pub. No.: US 2014/0164222 A1
(43) Pub. Date: Jun. 12, 2014

(54) Impulse Savings Using Savings Memoranda

(71) Applicant: BANK OF AMERICA CORPORATION, Charlotte, NC (US)

(72) Inventors: Tamara S. Kingston, Peoria, AZ (US); Glenn M. Grossman, Mathews, NC (US); Scott R. Enscoe, Waxhaw, NC (US)

(73) Assignee: Bank of America Corporation, Charlotte, NC (US)

(21) Appl. No.: 13/712,478

(22) Filed: Dec. 12, 2012

(51) Int. Cl. G06Q 40/00

(52) U.S. Cl. CPC G06Q 40/00
USPC 705/39

(57) ABSTRACT

A method includes receiving a message associated with a savings goal of a user, the message specifying an amount of money the user desires to contribute to the savings goal. The method further includes generating a savings memorandum associated with the savings goal that is stored in association with the savings goal and displaying the savings memorandum to the user along with a selectable option allowing the user accept, decline, or modify the savings memorandum. The method further includes initiating the transfer of the amount of money from a first account of the user to a second account of the user in response to a user selection to accept the savings memorandum, the second account being associated with the savings goal.

### TECHNICAL FIELD OF THE INVENTION

This disclosure relates generally to savings account management and more particularly to impulse savings using savings memoranda.

### BACKGROUND OF THE INVENTION

Financial institutions often allow customers to maintain one or more financial accounts, including, for example, savings accounts and checking accounts. In certain circumstances, a customer may be able to maintain a financial account by adding funds to the account, withdrawing funds from the account, or transferring funds to another account. For example, the customer maintain a financial account by accessing that account through on Internet website.

### SUMMARY OF THE INVENTION

According to embodiments of the present disclosure, disadvantages and problems associated with previous systems for savings account management may be reduced or eliminated.

In certain embodiments, a method includes receiving a message associated with a savings goal of a user, the message specifying an amount of money the user desires to contribute to the savings goal. The method further includes generating a savings memorandum associated with the savings goal that is stored in association with the savings goal and displaying the savings memorandum to the user along with a selectable option allowing the user accept, decline, or modify the savings memorandum. The method further includes initiating the transfer of the amount of money from a first account of the user to a second account of the user in response to a user selection to accept the savings memorandum, the second account being associated with the savings goal.

Certain embodiments of the present disclosure may provide one or more technical advantages. For example, certain embodiments of the present disclosure may facilitate the generation of a savings memorandum in response to a message specifying an amount a user desires to contribute to a savings goal. Because that savings memorandum must be approved prior to applying the specified amount to the savings goal (i.e., transferring funds), the user is able to account for all savings memoranda (along with any other intervening factors) when deciding the amount of money to apply toward the savings goal.

Certain embodiments of the present disclosure may include some, all, or none of the above advantages. One or more other technical advantages may be readily apparent to those skilled in the art from the figures, descriptions, and claims included herein.

### BRIEF DESCRIPTION OF THE DRAWINGS

FIG. 1 illustrates an example system for impulse savings using savings memoranda, according to certain embodiments of the present disclosure; and

FIG. 2 illustrates an example method for impulse savings using savings memoranda, according to certain embodiments of the present disclosure.

### DETAILED DESCRIPTION OF THE INVENTION

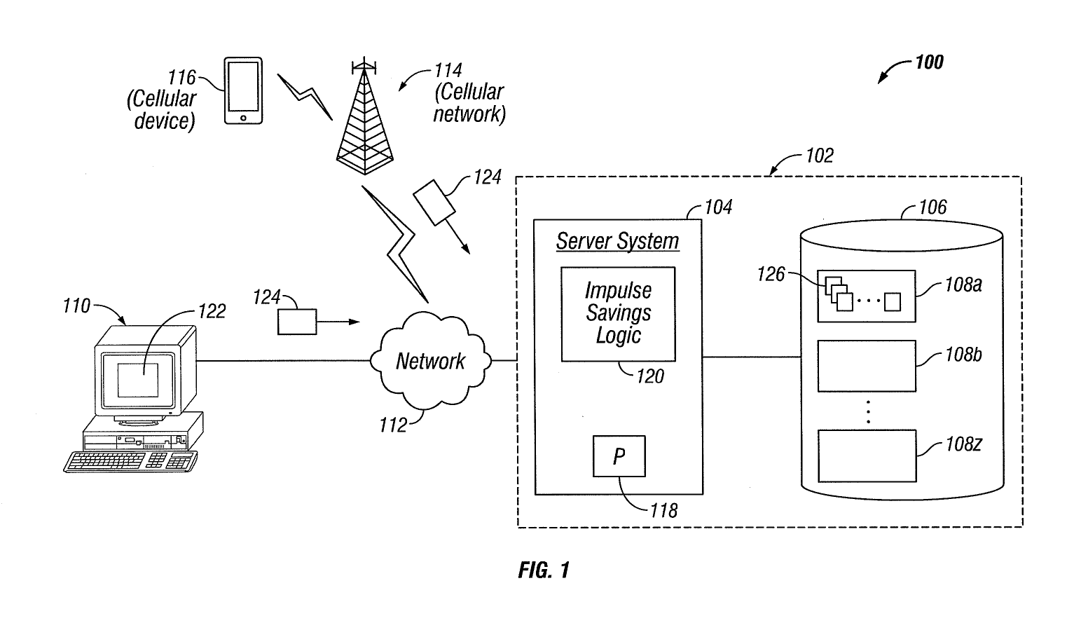

FIG. 1 illustrates an example system 100 for providing impulse savings using savings memoranda, according to certain embodiments of the present disclosure. System 100 may include an account management system 102 associated with a financial institution, the account management system 102 including a server system 104 and a database 106. For example, the financial institution may allow its customers to manage information associated their financial accounts 108 using account management system 102. To facilitate that account management, one or more customer systems 110 may be configured to communicate with account management system 102 via a network 112. In addition, one or more cellular networks 114 may be configured to communicate with account management system 102 (e.g., via network 112) such that customers may manage their financial accounts 108 via mobile devices 116. Although this particular implementation of system 100 is illustrated and primarily described, the present invention contemplates any suitable implementation of system 100 according to particular needs.

In general, system 100 is operable to allow customers of a financial institution to manage the allocation of funds among the customer's financial accounts 108 (e.g., savings accounts and/or checking accounts). In certain embodiments, a particular account 108 of the customer (or sub-account within an account 108) may be associated with pre-established savings goal of the customer (e.g., a vacation fund), and the customer may wish to apply funds from another account 108 (e.g., a checking account) to the account 108 associated with the savings goal. Because the customer's desire to apply funds to the account 108 associated with the savings goal may be tied to an impulse experienced by the user (e.g., an unexpected savings on the purchase of goods), certain embodiments of the present disclosure may facilitate the real-time generation of a message documenting the customer's desire to transfer a specified amount (an impulse savings message 124, described below). That generated message may be communicated to account management system 102, and a savings memorandum 126 (described in detail below) may be generated and stored in association with the account 108 associated with the savings goal. Subsequently, the customer may review the savings memorandum 126 (along with any other pending savings memoranda 126 stored in association with the account 108) in order to decide whether to accept, decline, or modify the memorandum. As a result, the customer is given the ability to document impulsive savings decisions while also being able to review those decisions prior to the actual transfer of funds.

Account management system 102 may include any suitable system operable to allow customers of a financial institution to manage the allocation of funds among the customer's financial accounts 108 (e.g., savings accounts and/or checking accounts). In certain embodiments, account management system 102 may include a server system 104. Server system 104 may include one or more electronic computing devices operable to receive, transmit, process, and store data associated with system 100. For example, server system 104 may include one or more general-purpose PCs, Macintoshes, workstations, Unix-based computers, server computers, one or more server pools, or any other suitable devices. Server system 104 may include one or more processing modules 118, each of which may include one or more microprocessors, controllers, or any other suitable computing devices or resources. Processing modules 118 may work, either alone or with other components of system 100, to provide a portion or all of the functionality of system 100 described herein. In short, server system 104 may include any suitable combination of software, firmware, and hardware. Although a single server system 104 is illustrated, the present disclosure contemplates system 100 including any suitable number of server systems 104. Moreover, although referred to as a “server system,” the present disclosure contemplates server system 104 comprising any suitable type of processing device or devices.

Server system 104 may additionally include (or be communicatively coupled to) a database 106. Database 106 may comprise any suitable memory module and may take the form of volatile or non-volatile memory, including, without limitation, magnetic media, optical media, RAM, ROM, removable media, or any other suitable local or remote memory component. In certain embodiments, database 106 may store information associated with customer accounts 108 (e.g., the name of the customer holding the account 108, the account number of the account 108, the account balance of the account 108, and any other information associated with the account 108). A “customer accounts 108,” as used herein, may refer to any checking account, savings account, credit account, or other account held by the financial institution for the customer. Moreover, although each financial account 108 is individually depicted, the present disclosure contemplates that a financial account 108 may include a sub-account within a larger checking account, savings account, credit account, or other account held by the financial institution for the customer.

In certain embodiments, server system 110 may include impulse savings logic 120. Impulse savings logic 120 may include any suitable combination of hardware, firmware, and software operable to facilitate the transfer of funds between accounts 108 of a customer of a financial institution. In order to allow a customer to manage the transfer of funds between accounts 108 (as described in detail below), customers may be able to interact with account management system 102 (including impulse savings logic 120) via network 112. Network 112 may facilitate wireless or wireline communication and may communicate, for example, IP packets, Frame Relay frames, Asynchronous Transfer Mode (ATM) cells, voice, video, data, and other suitable information between network addresses. Network 112 may include one or more local area networks (LANs), radio access networks (RANs), metropolitan area networks (MANs), wide area networks (WANs), all or a portion of the global computer network known as the Internet, and/or any other communication system or systems at one or more locations.

For example, a customer system 110 may be communicatively coupled to account management system 102 via network 112. Customer system 110 may include any suitable device or combination of devices operable to allow a customer to access all or a portion of the functionality associated with account management system 102 (as described in detail below). For example, customer system 110 may include one or more computer systems at one or more locations. A computer system, as used herein, may include a personal computer, workstation, network computer, kiosk, wireless data port, personal data assistant (PDA), tablet computer, one or more processors within these or other devices, or any other suitable processing device. Additionally, each computer system may include any appropriate input devices (such as a keypad, touch screen, mouse, or other device that can accept information), output devices, mass storage media, or other suitable components for receiving, processing, storing, and communicating data. Both the input device and output device may include fixed or removable storage media such as a magnetic computer disk, CD-ROM, or other suitable media.

In certain embodiments, customer system 110 may include a graphical user interface (GUI) 122, which may be delivered using an online portal, hypertext mark-up language (HTML) pages for display and data capture, or in any other suitable manner. GUI 122 may allow a user of customer system 110 to interact with other components of system 100. For example, GUI 122 may allow a user of user system 102 to access all or a portion of the functionality associated with account management system 102 (as described in further detail below). Although a single user system 102 is depicted and described, the present disclosure contemplates that system 100 may include any suitable number of user systems 102, according to particular needs.

As another example, a cellular network 114 may be communicatively coupled to account management system 102 via network 112 such that a customer may interact with account management system 102 via a mobile device 116 (e.g., a mobile phone, smart phone, tablet computer, or any other suitable mobile device). In certain embodiments, such interaction may be facilitated by a mobile application associate with account management system 102 stored on the mobile device.

Although customers are described as being able to interact with account management system 102 via a customer system 110 and a mobile device 116, the present disclosure contemplates that a customer may interact with account management system 102 using any suitable device, according to particular needs.

In certain embodiments, impulse savings logic 120 may allow a customer to create (e.g., via customer system 110, mobile device 116, or any other suitable device) a savings goal, and the savings goal may be associated with an account 108 such that the customer can contribute funds to the savings goal. As discussed above, the present disclosure contemplates that the account 108 associated with the savings goal may be a sub-account (e.g., a sub-account of a savings account held by the customer). For example, a particular customer may desire to take a vacation and may set up a savings goal specify an amount needed to pay for the vacation. In response, impulse savings logic 120 may create an account 108 (e.g., account 108a) associated with the savings goal.

In order to allow a customer to contribute funds to a pre-established savings goal, impulse savings logic 120 may be operable to receive impulse savings requests 124 from a customer. As one example, a mobile device 116 of a customer may include a mobile application allowing the customer to specify an amount of money to contribute to a savings goal previously established by that customer. For example, the customer may save an amount of money over what was previously allocated when shopping for groceries (e.g., through the use of coupons), and the customer may wish to transfer that saved amount to an account associated with a vacation fund (e.g., account 108a, as discussed above). In response to specifying an amount to contribute to a savings goal, an impulse savings request 124 specifying the amount and the account 108 associated with the savings goal may be communicated to impulse savings logic 120. As another example, a customer may set a pre-established schedule according to which impulse savings requests 124 are communicated to account management system 102 (e.g., an amount of money the customer wishes to transfer to an account associated with a vacation fund on a weekly basis). As yet another example, impulse savings requests 124 may be automatically generated in response to savings by a customer on spending is select merchant categories. Foe example, the customer may allocate a weekly budget for spending in a particular merchant category (e.g., groceries), and, at the end of a particular week, an impulse savings requests 124 specifying the amount of unspent budget for that week may be automatically generated.

In certain embodiments, impulse savings logic 120 may be further operable to generate a savings memorandum 126 based on a received impulse savings message. For example, a generated savings memorandum 126 may specify the amount of funds the customer desires to transfer, the savings goal and/or associated account 108 the customer desires to transfer the funds to (e.g., account 108a, which may be an account associated with a vacation fund of the customer), the account 108 the customer desires to transfer the funds from (e.g., account 108b, which may be a savings account of the customer), and any other suitable information. The generated savings memorandum 126 may be store in association with the account 108 associated with the savings goal (e.g., account 108a).

In certain embodiments, impulse savings logic 120 may be further operable to display (e.g., via GUI 122, mobile device 116, or in any other suitable manner) one or more previously-generated savings memoranda 126 to the customer holding the account 108 in association with which the savings memoranda 126 are stored. In addition, impulse savings logic 120 may present to the customer a selectable option associated with each savings memorandum 126 allowing the customer to accept, decline, or modify the savings memorandum 126. In response to a user selection to accept a savings memorandum 126, impulse savings logic 120 may initiate a transfer of the specified amount of funds from the specified source account 108 (e.g., account 108b, which may be a savings account of the customer as described above) to the account 108 associated with the specified savings goal (e.g., account 108a, which may be an account associated with a vacation fund of the customer). In certain embodiments, the initiated transfer may take place at a time specified by the customer. In response to a user selection to decline a savings memorandum 126, impulse savings logic 120 may delete the savings memorandum 126 without transferring any funds. In response to a user selection to modify a savings memorandum 126, impulse savings logic 120 may (1) allow the user to modify the amount specified in the savings memorandum and/or the source/destination accounts 108, and (2) initiate a transfer of the (newly) specified amount of funds from the (newly) specified source account 108 to the account 108 associated with the (newly) specified savings goal.

In certain embodiments, impulse savings logic 120 may be further operable to generate a progress report associated with an account 108 that is associated with a savings goal of the user. For example, impulse savings logic 120 may generate a display (e.g., displayed to the user via GUI 122) graphically depicting the amount the customer has contributed to the account (e.g., via the above -discussed savings memoranda or otherwise) relative to the goal amount specified by the customer.

Particular embodiments of the present disclosure may provide one or more technical advantages. For example, because savings logic 120 may generate a savings memorandum 126 in response to an impulse savings message 124 specifying an amount the user desires to contribute to a savings goal and that savings memorandum 126 must be approved prior to applying the specified amount to the savings goal (i.e., transferring funds), the customer is able to account for all savings memoranda 126 (along with any other intervening factors) when deciding the amount of money to apply toward the savings goal.

Although a particular implementation of system 100 is illustrated and primarily described, the present disclosure contemplates any suitable implementation of system 100 according to particular needs. Although a particular number of components of system 100 have been illustrated and primarily described above, the present invention contemplates system 100 including any suitable number of such components. Furthermore, the various components of system 100 described above may be local or remote from one another. Additionally, the components of system 100 may be implemented in any suitable combination of hardware, firmware, and software.

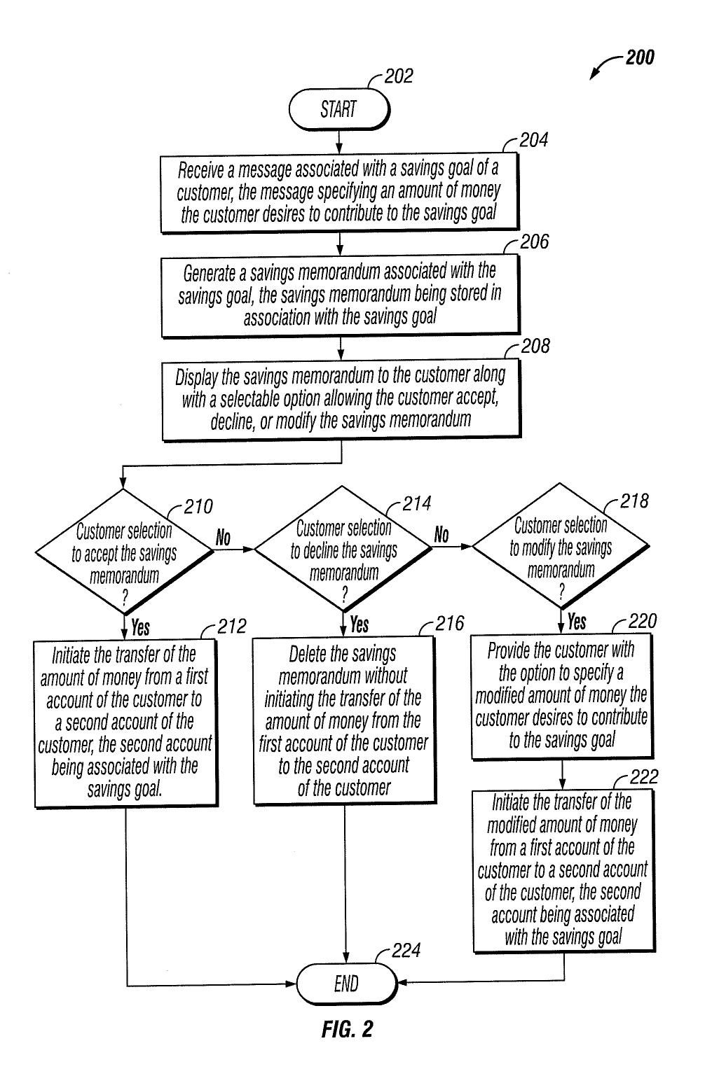

FIG. 2 illustrates an example method 200 for impulse savings using savings memoranda, according to certain embodiments of the present disclosure. The method begins at step 202. At step 204, account management system 102 receives an impulse savings message 124 associated with a savings goal of a customer, the message specifying an amount of money the customer desires to contribute to the savings goal. At step 206, account management system 102 generates a savings memorandum 126 associated with the savings goal. As described above, the savings memorandum 126 may include the amount of money the customer desires to transfer, the savings goal and/or associated account 108 the customer desires to transfer the money to, and the account 108 the customer desires to transfer the money from. The generated savings memorandum may be stored in association with an account 108 associate with the specified savings goal.

At step 208, account management system 102 displays the generated savings memorandum 126 to the customer along with a selectable option allowing the customer accept, decline, or modify the savings memorandum 126. If, at step 210, the customer selects to accept the savings memorandum 126, account management system 102, at step 212, initiates the transfer of the amount of money from a first account of the customer to a second account of the customer, the second account being associated with the savings goal. The method then ends at step 224. If, at step 214, the customer selects to decline the savings memorandum 126, account management system 102, at step 216, deletes the savings memorandum 126 without initiating the transfer of the amount of money from the first account of the customer to the second account of the customer. The method then ends at step 224. If, at step 218, the customer selects to modify the savings memorandum 126, account management system 102 (1) at step 220, provides the customer with the option to specify a modified amount of money the customer desires to contribute to the savings goal, and (2) at step 222, initiates the transfer of the modified amount of money from the first account of the customer to the second account of the customer. The method then ends at step 224.

Although the steps of method 200 have been described as being performed in a particular order, the present disclosure contemplates that the steps of method 200 may be performed in any suitable order, according to particular needs.

Although the present disclosure has been described with several embodiments, diverse changes, substitutions, variations, alterations, and modifications may be suggested to one skilled in the art, and it is intended that the invention encompass all such changes, substitutions, variations, alterations, and modifications as fall within the spirit and scope of the appended claims.

1. A method, comprising:
receiving, by a server system comprising at least one computer, a message associated with a savings goal of a user, the message specifying an amount of money the user desires to contribute to the savings goal, wherein the server system is associated with a financial institution and the user is a customer of the financial institution, the financial institution maintaining a plurality of customer accounts for the user;
generating, by the at least one computer, a savings memorandum associated with the savings goal, the savings memorandum being stored in association with the savings goal;
transmitting, by the at least one computer, the savings memorandum to the user along with a selectable option allowing the user accept, decline, or modify the savings memorandum; and
in response to a user selection to accept the savings memorandum, initiating, by the at least one computer, the transfer of the amount of money from a first customer account maintained by the financial institution on behalf of the user to a second customer account maintained by the financial institution on behalf of the user, the second customer account being associated with the savings goal.

2. The method of claim 1, further comprising generating a progress report displaying a total amount of money in the second customer account of the user relative to the savings goal of the user.

3. The method of claim 1, further comprising:
receiving an additional message associated with the savings goal of the user, the additional message specifying an additional amount of money the user desires to contribute to the savings goal;
generating an additional savings memorandum associated with the savings goal, the additional savings memorandum being stored in association with the savings goal;
displaying the additional savings memorandum to the user along with a selectable option allowing the user accept, decline, or modify the additional savings memorandum; and
in response to a user selection to decline the additional savings memorandum, deleting the additional savings without initiating the transfer of the additional amount of money from the first customer account of the user to the second customer account of the user.

4. The method of claim 1, further comprising:
receiving an additional message associated with the savings goal of the user, the additional message specifying an additional amount of money the user desires to contribute to the savings goal;
generating an additional savings memorandum associated with the savings goal, the additional savings memorandum being stored in association with the savings goal;
displaying the additional savings memorandum to the user along with a selectable option allowing the user accept, decline, or modify the additional savings memorandum;
in response to a user selection to modify the additional savings memorandum, providing the user with the option to specify a modified additional amount of money the user desires to contribute to the savings goal; and
initiating the transfer of the modified additional amount of money from the first customer account of the user to the second custumer account of the user.

5. The method of claim 1, wherein the message associated with a savings goal of the user is generated by a mobile device of the user.

6. The method of claim 5, wherein the message associated with a savings goal of the user comprises a text message.

7. The method of claim 5, wherein the message associated with a savings goal of the user comprises a mobile application message generated by a mobile application of the mobile device of the user.

8. The method of claim 1, wherein the second customer account is a sub-account of the first customer account.

9. A system, comprising:
one or more memory modules storing a message associated with a savings goal of a user, the message specifying an amount of money the user desires to contribute to the savings goal, the one or more memory modules associated with a financial institution and the user being a customer of the financial institution, the financial institution maintenance a plurality of customer accounts for the user, and
one or more processing modules associated with the financial institution operable to:
access the message associated with the savings goal of a user;
generate a savings memorandum associated with the savings goal, the savings memorandum being stored in association with the savings goal;
transmit the savings memorandum to the user along with a selectable option allowing the user accept, decline, or modify the savings memorandum; and
in response to a user selection to accept the savings memorandum, initiate the transfer of the amount of money from a first customer account maintained by the financial institution on behalf of the user to a second customer account maintained by the financial institution on behalf of the user, the second customer account being associated with the savings goal.

10. The system of claim 9, wherein the one or more processing modules are further operable to generate a progress report displaying a total amount of money in the second customer account of the user relative to the savings goal of the user.

11. The system of claim 9, wherein:
the one or more memory modules store an additional message associated with the savings goal of the user, the additional message specifying an additional amount of money the user desires to contribute to the savings goal;
the one or more processing modules are further operable to:
access the additional message associated with the savings goal of a user;
generate an additional savings memorandum associated with the savings goal, the additional savings memorandum being stored in association with the savings goal;
display the additional savings memorandum to the user along with a selectable option allowing the user accept, decline, or modify the additional savings memorandum; and
in response to a user selection to decline the additional savings memorandum, delete the additional sayings without initiating the transfer of the additional amount of money from the first customer account of the user to the second customer account of the user.

12. The system of claim 9, wherein:
the one or more memory modules store an additional message associated with the savings goal of the user, the additional message specifying an additional amount of money the user desires to contribute to the savings goal;
the one or more processing modules are further operable to:
access the additional message associated with the savings goal of a user;
generate an additional savings memorandum associated with the savings goal, the additional savings memorandum being stored in association with the savings goal;
display the additional savings memorandum to the user along with a selectable option allowing the user accept, decline, or modify the additional savings memorandum;
in response to a user selection to modify the additional savings memorandum, provide the user with the option to specify a modified additional amount of money the user desires to contribute to the savings goal; and
initiate the transfer of the modified additional amount of money from the first customer account of the user to the second customer account of the user.

13. The system of claim 9, wherein the message associated with a savings goal of the user is generated by a mobile device of the user.

14. The system of claim 13, wherein the message associated with a savings goal of the user comprises a text message.

15. The system of claim 13, wherein the message associated with a savings goal of the user comprises a mobile application message generated by a mobile application of the mobile device of the user.

16. The system of claim 9, wherein the second customer account is a sub-account of the first customer account.

17. A non-transitory computer-readable medium encoded with logic, the logic operable when executed to:
receive a message associated with a savings goal of a user, the message specifying an amount of money the user desires to contribute to the savings goal;
generate a savings memorandum associated with the savings goal, the savings memorandum being stored in association with the savings goal;
transmit the savings memorandum to the user along with a selectable option allowing the user accept, decline, or modify the savings memorandum; and
in response to a user selection to accept the savings memorandum, initiate the transfer of the amount of money from a first customer account maintained by a financial institution on behalf of the user to a second customer account maintained by the financial institution on behalf of the user, the second customer account being associated with the savings goal, the user being a customer of the financial institution.

18. The computer-readable medium of claim 17, wherein the logic is further operable when executed to generate a progress report displaying a total amount of money in the second customer account of the user relative to the savings goal of the user.

19. The computer-readable medium of claim 17, wherein the logic is further operable when executed to:
receive an additional message associated with the savings goal of the user, the additional message specifying an additional amount of money the user desires to contribute to the savings goal;
generate an additional savings memorandum associated with the savings goal, the additional savings memorandum being stored in association with the savings goal;
display the additional savings memorandum to the user along with a selectable option allowing the user accept, decline, or modify the additional savings memorandum; and
in response to a user selection to decline the additional savings memorandum, delete the additional savings without initiating the transfer of the additional amount of money from the first customer account of the user to the second customer account of the user.

20. The computer-readable medium of claim 17, wherein the logic is further operable when executed to:
receive an additional message associated with the savings goal of the user, the additional message specifying an additional amount of money the user desires to contribute to the savings goal;
generate an additional savings memorandum associated with the savings goal, the additional savings memorandum being stored in association with the savings goal;
display the additional savings memorandum to the user along with a selectable option allowing the user accept, decline, or modify the additional savings memorandum;
in response to a user selection to modify the additional savings memorandum, provide the user with the option to specify a modified additional amount of money the user desires to contribute to the savings goal; and
initiate the transfer of the modified additional amount of money from the first customer account of the user to the second customer account of the user.

21. The computer-readable medium of claim 17, wherein the message associated with a savings goal of the user is generated by a mobile device of the user.

22. The computer-readable medium of claim 21, wherein the message associated with a savings goal of the user comprises a text message.

23. The computer-readable medium of claim 21, wherein the message associated with a savings goal of the user comprises a mobile application message generated by a mobile application of the mobile device of the user,

24. The computer-readable medium of claim 17, wherein the second customer account is a sub-account of the first customer account.
